(19) United States
(12) Patent Application Publication
(10) Pub. No.: US 2014/0216554 A1
(43) Pub. Date: Aug. 7, 2014

(54) Dye-Sensitized Solar Cell with Energy-Donor Material Enhancement

(71) Applicants: Sean Vail, Vancouver, WA (US); David Evans, Beaverton, OR (US); Wei Pan, Vancouver, WA (US)

(72) Inventors: Sean Vail, Vancouver, WA (US); David Evans, Beaverton, OR (US); Wei Pan, Vancouver, WA (US)

(21) Appl. No.: 13/762,527

(22) Filed: Feb. 8, 2013

Related U.S. Application Data
(63) Continuation-in-part of application No. 13/758,819, filed on Feb. 4, 2013.

(51) Int. Cl. H01G 9/20; H01G 9/00

(52) U.S. Cl. CPC H01G 9/2004; H01G 9/0029
USPC 136/263; 438/94

(57) ABSTRACT

A dye-sensitized solar cell (DSC) is provided with energy-donor enhancement. A transparent conductive oxide (TCO) film is formed overlying a transparent substrate, and an n-type semiconductor layer is formed overlying the TCO. The n-type semiconductor layer is exposed to a dissolved dye (D1) having optical absorbance local maximums at a first wavelength (A1) and second wavelength (A2), longer than the first wavelength. The n-type semiconductor layer is functionalized with the dye (D1), forming a sensitized n-type semiconductor layer. A redox electrolyte is added that includes a dissolved energy-donor material (ED1) in contact with the sensitized n-type semiconductor layer. The energy-donor material (ED1) is capable of non-radiative energy transfer to the dye (D1), which is capable of charge transfer to the n-type semiconductor. In one aspect, the dye (D1) is a metalloporphyrin, such as zinc porphyrin (ZnP), and the energy-donor material (ED1) includes a perylene-monoimide material or chemically modified perylene-monoimide material.

### RELATED APPLICATIONS

This application is a Continuation-in-Part of an application entitled, DYE-SENSITIZED SOLAR CELL VIA CO-SENSITIZATION WITH COOPERATIVE SENSITIZING DYES, invented by Sean Vail et al., Ser. No. 13/758,819, filed Feb. 4, 2013, attorney docket No. SLA3045, which is incorporated herein by reference.

### BACKGROUND OF THE INVENTION

1. Field of the Invention

This invention generally relates to dye-sensitive light absorbing chemistry and, more particularly, to dye-sensitized solar cells (DSCs) demonstrating enhanced photovoltaic performance with energy-donor materials in the electrolyte.

2. Description of the Related Art

Although dye-sensitized solar cells (DSCs) have the potential to provide solar power as a clean, affordable, and sustainable technology, many challenges continue to persist. Overall, DSCs can provide power conversion efficiencies (PCEs) comparable to a variety of thin-film technologies with the advantage of reduced cost, both in terms of materials and processing. Despite the fact that high PCEs have been achieved in DSCs using mono-sensitization, many sensitizing dyes suffer from a deficiency in optical absorption beyond 700 nanometers (nm). Furthermore, the choice of sensitizer is typically limited to those exhibiting broad absorption yet weak absorbance, or strong absorbance over a narrow wavelength region. In both cases, a considerable fraction of the incident sunlight fails to be effectively harnessed.

Conventionally, ruthenium complexes have proven to be among the most efficient sensitizers for DSC applications. Despite this fact, only incremental improvements in PCE have been achieved using ruthenium complexes within the past decade. Considering the facts that ruthenium complexes are expensive and ruthenium itself is a rare metal, there exists significant motivation to develop novel sensitizers that either contain abundant, inexpensive metals or are entirely free of metals.

Although shown to be efficient sensitizers for DSC, the typical optical absorption features of porphyrins are dominated by strong absorbance at shorter wavelengths (Soret band), weaker absorbance at longer wavelengths (Q-bands), and with absorbance approaching zero in the intermittent region. Overall, the deficiency in absorbance over broad wavelength regions necessarily places limitations on porphyrin performance in DSC. Nevertheless, the more recently demonstrated potential for porphyrin sensitizers has positioned this class of materials as a legitimate rival to traditional ruthenium complexes for DSC applications.¹

Certainly, one of the major limitations towards the realization of more efficient DSCs exists in an inability to construct a cell with an appropriate sensitizer that absorbs both strongly and broadly along wavelengths leading up to 1000 nm (or beyond) within a reasonably thin absorbing layer. Currently, there exists no such individual sensitizer candidate capable of satisfying this requirement. Although tandem cells have been considered as viable alternatives to single junction DSC, the lack of efficient infrared (IR)-absorbing sensitizers prevents effective current matching. In light of this, exploitation of Förster resonance energy transfer (FRET) in DSC may prove to be a valuable strategy for increasing photovoltaic performance.^{2,3} In general, FRET is the mechanism through which a photo-excited molecule transfers excitation energy in a nonradiative fashion to a different molecule located in close proximity.

Hardin et al. reported a FRET-enhanced performance for DSC through utilization of tetra-(4-tert-butylphenoxy)perylene tetracarboxylic acid dimide (PTCDI) and zinc tri-tert-butyl-phthalocyanine (TT1) as donor (energy relay dye, ERD) and acceptor, respectively.^{4,5} Overall, the combination of PTCDI and TT1 provided excellent spectral matching with respect to donor (PTCDI) fluorescence and acceptor (TT1) absorption. DSCs fabricated without ERD (0 mM PTCDI) yielded PCE=2.55% while those containing 13 mM PTCDI dissolved in electrolyte demonstrated an increased PCE (3.21%), whereby the corresponding 26% increase in performance for the DSC containing ERD was attributed to an amplified short-circuit current density (J_{sc}). Yum et al. successfully demonstrated an increase in light harvesting capability and corresponding photo-response in DSC as a result of FRET from two ERDs to a zinc phthalocyanine sensitizer.⁶ Overall, a 35% increase in photovoltaic performance was realized by taking advantage of complementary absorption spectra for the energy relay dyes and high excitation transfer efficiencies. Hardin et al. employed 4-(dicyanomethylene)-2-methyl-6-(4-dimethylaminostyryl)-4H-pyran as ERD in combination with a near-IR (NIR) sensitizer (TT1) to increase PCE from 3.5% to 4.5% in DSC.⁷ Furthermore, an excitation transfer efficiency of 96% was determined for the ERD in TT1-sensitized TiO₂ films. Shankar et al. reported the occurrence of FRET with near quantitative energy transfer efficiency between a zinc phthalocyanine (ZnPc-TTB) dissolved in electrolyte and TiO₂ nanowire-bound ruthenium dyes in DSC.⁸ The external quantum efficiency (EQE) of the FRET-based DSC with Black dye as sensitizer increased accordingly with an increase in ZnPc-TTB concentration in the electrolyte, which can be rationalized in terms of the fact that higher donor concentrations increases the probability that donors and acceptors are located in close proximity. Hoke et al. employed an analytic theory to calculate the excitation transfer efficiency from ERD to sensitizer through which it was determined that the excitation transfer efficiency can exceed 90% for the appropriate candidates.⁹ Finally, efficient FRET phenomena were shown to be operative in DSCs containing quantum dot “antennas” incorporated in the titania electrode when used in combination with sensitizing dyes that function as acceptors for energy transfer.^{10,11}

Yum et al. observed FRET-enhanced performance in a solid-state DSC (ssDSC) using a squarine sensitizer (SQ1) in combination with a highly phosphorescent phenanthroline ruthenium(II) complex (N877) as ERD.¹² For ssDSC fabricated with SQ1 as sensitizer, the incident photon-to current efficiency (IPCE) exceeded 47% at the wavelength corresponding to the maximum absorption of SQ1. Upon introduction of N877 (10 mM concentration) into the solid-state hole transport material (Spiro-OMeTAD), IPCE values increased to 8% and 21% at 460 nm and 400 nm, respectively, which was accompanied by corresponding increases in J_{sc} and PCE of 30% and 29%, respectively. Mor et al. reported a FRET-based maximum IPCE contribution of 25% with a corresponding excitation energy transfer efficiency ˜67.5% for a TiO₂ nanotube-based ssDSC using a squarine-based (SQ-1) sensitizer in combination with an ERD.¹³ Brown et al. employed co-sensitization with a visible light-absorbing organic sensitizer (D102) and a NIR-absorbing zinc phthalocyanine complex to enhance the optical window in ssDSCs with Spiro-OMeTAD as HTM.¹⁴ The co-sensitized ssDSCs demonstrated PCE=4.7% compared to 3.9% for the best mono-sensitized device. Trang et al. demonstrated FRET between fluorescent (donor) materials contained within a polymeric gel electrolyte and a ruthenium complex (sensitizer and acceptor) on the surface of TiO₂, through which a 25% increase in PCE was achieved relative to devices fabricated from the pristine sensitizer.¹⁵

Siegers et al. described the utilization of energy transfer to improve light harvesting and photocurrent generation in DSC based upon a co-sensitized system consisting of a carboxy-functionalized 4-aminonaphthalimide dye (carboxy-fluorol) as donor and N719 dye as acceptor.¹⁶ Similarly, Hardin et al. demonstrated successful photocurrent generation via intermolecular energy transfer from an NIR-absorbing zinc naphthalocyanine (AS02) co-sensitized with a metal complex dye (C106) on the TiO₂ surface.^{17,18} Griffith et al. reported a 300% efficiency enhancement in DSC using co-sensitization with two porphyrins for which IPCE data indicated an improved charge injection yield.¹⁹ Shrestha et al. described co-sensitization using an organic dye (BET) with 2 different porphyrins (TMPZn or LD12).²⁰ For DSC, an increase in PCE from 1.09% to 2.90% was demonstrated through co-sensitization with TMPZn and BET relative to TMPZn alone. With respect to co-sensitization using LD12 and BET, an increase in PCE from 6.65% to 7.60% was achieved relative to DSCs fabricated from LD12. Since direct electron injection from photo-excited BET to TiO₂ was determined to be inefficient, an intramolecular energy transfer model was proposed in order to account for the beneficial impact from co-sensitization.

Siegers et al. reported the synthesis of an chromophoric dyad consisting of an alkyl-functionalized aminonaphthalimide (energy donor) and [Ru(dcbpy)₂(acac)]Cl (dcbpy=4,4′-dicarboxybipyridine, acac=acetylacetonato), the latter of which functioned as both energy acceptor and sensitizer.²¹ For DSC, a photovoltaic enhancement was demonstrated for the dyad as sensitizer relative to [Ru(dcbpy)₂(acac)]Cl in the form of increased photocurrent through energy transfer from donor to acceptor moieties. Finally, Kirmaier et al. described the excited-state photodynamics of covalent porphyrin-perylene architectures through which it was shown that efficient energy transfer proceeds from the photo-excited perylene to porphyrin, while unfavorable “quenching” mechanisms such as electron transfer from porphyrin to perylene, were essentially suppressed in most cases.²²
1. L-L. Li and E. W-G. Diau, “Porphyrin-Sensitized Solar Cells”, Chemical Society Reviews 2013, 42, 291-304.
2. J. I. Basham, G. K. Mor and C. A. Grimes, “Förster Resonance Energy Transfer in Dye-Sensitized Solar Cells”, ACS Nano 2010, 4, 1253-1258.
3. B. E. Hardin, H. J. Snaith and M. D. McGehee, “The Renaissance of Dye-Sensitized Solar Cells”, Nature Photonics 2012, 6, 162-169.
4. B. E. Hardin, E. T. Hoke, P. B. Armstrong, J-H. Yum, P. Comte, T. Torres, J. M. J. Fréchet, M. K. Nazeeruddin, M. Gratzel and M. D. McGehee, “Increased Light Harvesting in Dye-Sensitized Solar Cells with Energy Relay Dyes”, Nature Photonics 2009, 3, 406-411.
5. B. E. Hardin and M. D. McGehee, “Using Energy Relay Dyes to Increase Light Absorption in Dye-Sensitized Solar Cells”, US2010/0307571 A1.
6. J-H. Yum, B. E. Hardin, E. T. Hoke, E. Baranoff, S. M. Zakeeruddin, M. K. Nazeeruddin, T. Torres, M. D. McGehee and M. Grätzel, “Incorporating Multiple Energy Relay Dyes in Liquid Dye-Sensitized Solar Cells”, Chem Phys Chem 2011, 12, 657-661.
7. B. E. Hardin, J-H. Yum, E. T. Hoke, Y. C. Jun, P. Pechy, T. Torres, M. L. Brongersma, M. K. Nazeeruddin, M. Grätzel and M. D. McGehee, “High Excitation Transfer Efficiency from Energy Relay Dyes in Dye-Sensitized Solar Cells”, Nano Letters 2010, 10, 3077-3083.
8. K. Shankar, X. Feng and C. A. Grimes, “Enhanced Harvesting of Red Photons in Nanowire Solar Cells: Evidence of Resonance Energy Transfer”, ACS Nano 2009, 3, 788-794.
9. E. T. Hoke, B. E. Hardin, and M. D. McGehee, “Modeling the Efficiency of Förster Resonant Energy Transfer from Energy Relay Dyes in Dye-Sensitized Solar Cells”, Optics Express 2010, 18, 3893-3904.
10. S. Buhbut, S. Itzhakov, E. Tauber, M. Shalom, I. Hod, T. Geiger, Y. Garini, D. Oron and A. Zaban, “Built-in Quantum Dot Antennas in Dye-Sensitized Solar Cells”, ACS Nano 2010, 4, 1293-1298.
11. S. Itzhakov, S. Buhbut, E. Tauber, T. Geiger, A. Zaban and D. Oron, “Design Principles of FRET-Based Dye-Sensitized Solar Cells with Buried Quantum Dot Donors”, Advanced Energy Materials 2011, 1, 626-633.
12. J-H. Yum, B. E. Hardin, S-J. Moon, E. Baranoff, F. Nüesch, M. D. McGehee, M. Gratzel and M. K. Nazeeruddin, “Panchromatic Response in Solid-State Dye Sensitized Solar Cells Containing Phosphorescent Energy Relay Dyes”, Angewandte Chemie International Edition 2009, 48, 9277-9280.
13. G. K. Mor, J. Basham, M. Paulose, S. Kim, O. K. Varghese, A. Vaish, S. Yoriya, C. A. Grimes, “High-Efficiency Förster Resonance Energy Transfer in Solid-State Dye Sensitized Solar Cells”, Nano Letters 2010, 10, 2387-2394.
14. M. D. Brown, P. Parkinson, T. Torres, H. Miura, L. M. Herz and H. J. Snaith, “Surface Energy Relay Between Cosensitized Molecules in Solid-State Dye-Sensitized Solar Cells”, Journal of Physical Chemistry C 2011, 115, 23204-23208.
15. T. T. Trang, J. H. Cheon, J. G. Lee and J. H. Kim, “Enhanced Light Harvesting from Först-Type Resonance Energy Transfer in the Quasi-Solid State Dye-Sensitized Solar Cells”, Journal of Nanoscience and Nanotechnology 2012, 12, 3301-3304.
16. C. Siegers, U. Würfel, M. Zistler, H. Gores, J. Holh-Ebinger, A. Hinsch and R. Haag, “Overcoming Kinetic Limitations of Electron Injection in the Dye Solar Cell via Coadsorption and FRET”, Chem Phys Chem 2008, 9, 793-798.
17. B. E. Hardin, A. Sellinger, T. Moehl, R. Humphrey-Baker, J-E. Moser, P. Wang, S. M. Zakeeruddin, M. Grätzel and M. D. McGehee, “Energy and Hole Transfer between Dyes Attached to Titania in Cosensitized Dye-Sensitized Solar Cells”, Journal of the American Chemical Society 2011, 133, 10662-10667.
18. B. E. Hardin and M. D. McGehee, “Increased Near-Infrared Light Harvesting in Dye-Sensitized Solar Cells Using Co-sensitized Energy Relay Dyes on Titania”, US2012/0255614 A1.
19. M. J. Griffith, A. J. Mozer, G. Tsekouras, Y. Dong, P. Wagner, K. Wagner, G. G. Wallace, S. Mori and D. L. Officer, “Remarkable Synergistic Effects in a Mixed Porphyrin Dye-Sensitized TiO₂ Film”, Applied Physics Letters 2011, 98, 163502.
20. M. Shrestha, L. Si, C-W. Chang, H. He, A. Sykes, C-Y. Lin and E. W-G. Diau, “Dual Functionality of BODIPY Chromophore in Porphyrin-Sensitized Nanocrystalline Solar Cells”, Journal of Physical Chemistry C 2012, 116, 10451-10460.
21. C. Siegers, J. Holh-Ebinger, B. Zimmerman, U. Würfel, R. Mülhaupt, A. Hinsch and R. Haag, “A Dyadic Sensitizer for Dye Solar Cells with High Energy-Transfer Efficiency in the Device”, Chem Phys Chem 2007, 8, 1548-1556.
22. C. Kirmaier, H. Song, E. Yang, J. K. Schwartz, E. Hindin, J R. Diers, R. S. Loewe, K. Tomizaki, F. Chevalier, L. Ramos, R. R. Birge, J. S. Lindsey, D. F. Bocian and D. Holten, “Excited-State Photodynamics of Perylene-Porphyrin Dyads. 5. Tuning Light-Harvesting Characteristics via Perylene Substituents, Connection Motif, and Three-Dimensional Architecture”, Journal of Physical Chemistry B 2010, 114, 14249-14264.

It would be advantageous if an energy-door material could be used in cooperation with a sensitizing dye to improve both the degree of optical absorbance and the range of wavelengths over which a DSC operates.

### SUMMARY OF THE INVENTION

Herein is described a strategy for improving the performance of dye-sensitized solar cells (DSCs) by exploiting an internal, energy transfer pathway. Rapid and efficient energy transfer from a photo-excited energy-donor contained in the electrolyte, to a zinc porphyrin (ZnP) sensitizer for example, has been confirmed through both fundamental, solution-based “quenching” experiments and significant improvements in DSC prototype performance. In the case of a DSC, the energy-donor material may be dissolved in the electrolyte in order to avoid competitive binding with ZnP along the TiO₂ surface. Using this approach, the overall efficiency may be increased from 4.2% for the control DSC, to >7.5% for the energy-donor device. These results confirm that FRET can be advantageously employed to compensate for deficiencies in sensitizer absorption over specific wavelength ranges, thereby providing a convenient method for enhancing light harvesting capabilities in DSC.

Accordingly, a method is provided for fabricating a dye-sensitized solar cell with energy-donor enhancement. A transparent conductive oxide (TCO) film is formed overlying a transparent substrate, and an n-type semiconductor layer is formed overlying the TCO. The n-type semiconductor layer is exposed to a dissolved dye (D1) having a first optical absorbance local maxima at a first wavelength (A1) and a second optical absorbance local maxima at a second wavelength (A2), longer than the first wavelength. The n-type semiconductor layer is functionalized with the dye (D1), forming a sensitized n-type semiconductor layer. Next, a redox electrolyte is added that includes a dissolved energy-donor material (ED1) in contact with the sensitized n-type semiconductor layer. The energy-donor material (ED1) is capable of non-radiative energy transfer to the dye (D1). The energy-donor material (ED1) has a third optical absorbance local maxima at a third wavelength (A3) between the first wavelength (A1) and the second wavelength (A2), and a first optical emission local maxima between the third wavelength (A3) and the second wavelength (A2). Finally, a counter electrode is formed overlying the redox electrolyte.

In one aspect, the dye (D1) is a metalloporphyrin, such as ZnP, and the energy-donor material (ED1) includes a perylene-monoimide material or chemically modified perylene-monoimide material.

Additional details of the above-described method, a DSC with energy-donor enhancement, and a method for generating photocurrent using a DSC with energy-donor enhancement, are provided below.

### BRIEF DESCRIPTION OF THE DRAWINGS

FIG. 1 is partial cross-sectional view of a dye-sensitized solar cell (DSC) with energy-donor enhancement.

FIG. 2 is a partial cross-sectional view depicting a variation of the DSC of FIG. 1.

FIG. 3 is a graph of conceptual absorbance and emission values vs. wavelength, associated with the DSC of FIGS. 1 and 2.

FIG. 4 is a graph of conceptual incident photon-to-current conversion efficiency (IPCE) values vs. wavelength, associated with the DSC of FIGS. 1 and 2.

FIG. 5 is a diagram depicting the molecular structure of 1,6,9-tris-(4-tert-butylphenoxy)-N-(2,6-diisopropyl phenyl)perylene-3,4-dicarboximide (TTBPP).

FIG. 6 is an illustration of effective spectral matching for Förster resonance energy transfer (FRET) from a photo-excited energy-donor to a sensitizing dye.

FIG. 7 is an illustration of the operative mechanisms in FRET-based DSC.

FIG. 8 is a graph depicting the optical absorption spectra of ZnP and TTBPP in dichloromethane (DCM), and ZnP co-adsorbed onto transparent TiO₂ substrates with deoxycholic acid (DCA) at a 1:1 molar ratio from 375-725 nm.

FIG. 9 is a graph depicting the emission spectra of TTBPP in DCM following irradiation at λ=534 nm, while monitoring at 550-700 nm.

FIG. 10 is a graph of IPCE spectra for DSCs fabricated using ZnP with triiodide electrolyte and ZnP containing 6 mM dissolved TTBPP in triiodide electrolyte from 300-800 nm.

FIG. 11 is a graph of the photovoltaic characteristics for a DSC fabricated using ZnP with triiodide electrolyte, containing 6 mM dissolved TTBPP.

FIG. 12 is a flowchart illustrating a method for fabricating a dye-sensitized solar cell with energy-donor enhancement.

FIG. 13 is a flowchart illustrating a method for generating photocurrent using a dye-sensitized solar cell with energy-donor enhancement.

### DETAILED DESCRIPTION

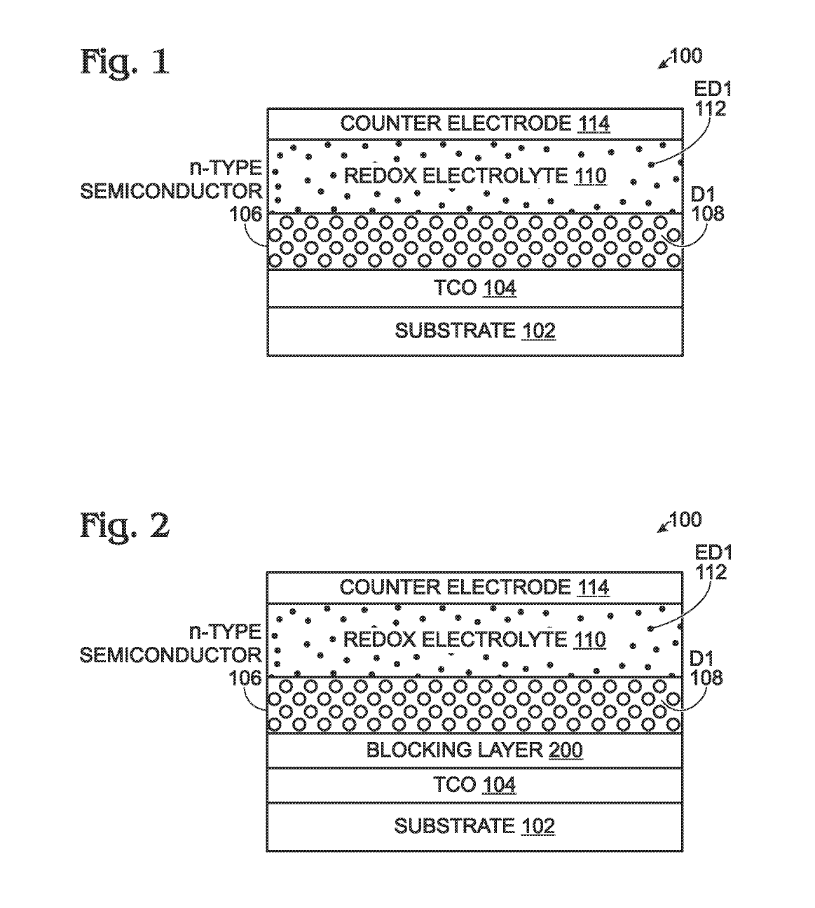

FIG. 1 is partial cross-sectional view of a dye-sensitized solar cell (DSC) with energy-donor enhancement. The DSC 100 comprises a transparent substrate 102, such as glass, and a transparent conductive oxide (TCO) film 104 overlying the transparent substrate 102. Some examples of TCO materials include fluorine-doped tin oxide (FTO) and indium tin oxide (ITO). An n-type semiconductor layer 106 overlies the TCO film 104, and is sensitized with a dye (D1) 108. As such, the dye (D1) 108 is capable of charge transfer at a surface of the n-type semiconductor 106. Alternatively stated, the dye (D1) 108 is functionalized to the n-type semiconductor layer 106. As is well understood by those with skill in the art, the functionalization of the n-type semiconductor implies the establishment of an intimate association between the dye and the n-type semiconductor surface through chemical bonding, complexation, and/or other modes through which electron injection from dye to n-type semiconductor following photo-excitation of the dye is facilitated.

The n-type semiconductor layer 106 may be made from metal oxides of titanium (TiO₂), aluminum (Al₂O₃), tin (SnO₂), magnesium (MgO), tungsten (WO₃), niobium (Nb₂O₅), or mixed metal oxides including more than one type of metal. The n-type semiconductor layer 106 may take the form of nanoparticles, nanotubes, nanorods, nanowires, or combinations of the above-mentioned morphologies. Other types of n-type semiconductor materials and forms are known in the art that would be applicable to DSC 100. A redox electrolyte 110 is in contact with the sensitized n-type semiconductor layer 106/108. Some examples of redox electrolytes include triiodide (I⁻/I₃_{^{−}}), cobalt (Co²⁺/Co³⁺), ferrocene (Fc/Fc⁺), p-type organic semiconductor molecules and polymers, and perovskite materials. The redox electrolyte 110 includes an energy-donor material (ED1) 112 dissolved in the redox electrolyte. The redox electrolyte 110 may be in the form of a liquid, solid, semi-solid, ionic liquid, or a combination of the above-mentioned forms. The energy-donor material (ED1) 112 is capable of non-radiative energy transfer to the dye (D1) 108. In the case of a “liquid” electrolyte (either conventional solvent or ionic liquid-based), the ED1 is “dissolved” in the electrolyte solvent along with redox active materials and remains dissolved in a DSC fabricated using such liquid electrolytes. In the case of a solid electrolyte (such as an organic semiconductor, polymer, etc.), the energy-donor is typically first dissolved in a solvent along with the p-type semiconducting moieties. Next, the mixture is applied to the sensitized n-type semiconductor. At this stage, solvent may be removed (or lost) to afford a solid/semi-solid composite that retains the ED1 within the electrolyte composite. A counter electrode 114, such as platinum, overlies the redox electrolyte 110.

FIG. 2 is a partial cross-sectional view depicting a variation of the DSC of FIG. 1. In this aspect, a blocking layer 200 is interposed between the TCO film 104 and the sensitized n-type semiconductor layer 106. In general, the blocking layer comprises a conductive film of metal oxide, such as TiO₂, or mixed metal oxide, which is applied as a thin layer.

FIG. 3 is a graph of conceptual absorbance and emission values vs. wavelength, associated with the DSC of FIGS. 1 and 2. The dye (D1) has a first optical absorbance local maxima at a first wavelength (A1) and a second optical absorbance local maxima at a second wavelength (A2), longer than the first wavelength. The energy-donor material (ED1) has a third optical absorbance local maxima at a third wavelength (A3) between the first wavelength (A1) and the second wavelength (A2), and a first optical emission local maxima between the third wavelength (A3) and the second wavelength (A2), at fourth wavelength (A4). As used herein, the term “local maxima” refers to a wavelength associated with relatively high absorbance (or emission), but not necessarily the wavelength of maximum absorbance (emission).

In one aspect, the dye (D1) includes a porphyrin material. More particularly, the porphyrin material may be a metalloporphyrin obtained by complexation with a transition metal. For example, the metalloporphyrin may be zinc porphyrin (ZnP). In another aspect, the energy-donor material (ED1) includes a perylene-monoimide material or chemically modified perylene-monoimide material. Typically, covalent chemical modification along the periphery of the perylene structure involves the strategic installation of functional chemical groups for the purposes of (1) fine-tuning absorption properties, (2) providing enhanced solubility, (3) suppressing aggregate formation, or (4) for achieving two or more of the above purposes. For example, the perylene-monoimide material may be 1,6,9-tris-(4-tert-butylphenoxy)-N-(2,6-diisopropyl phenyl)perylene-3,4-dicarboximide (TTBPP).

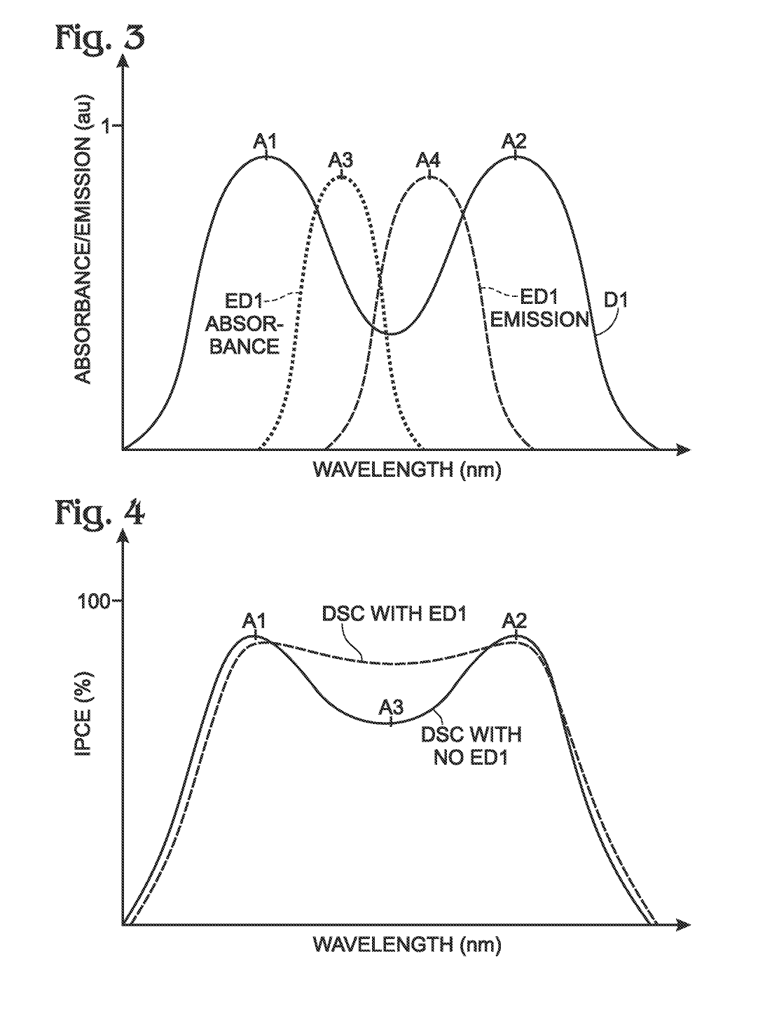

FIG. 4 is a graph of conceptual incident photon-to-current conversion efficiency (IPCE) values vs. wavelength, associated with the DSC of FIGS. 1 and 2. Without the influence of the energy-donor material (ED1), the DSC has a first IPCE at the first wavelength (A1), a second IPCE at the second wavelength (A2), and a third IPCE at the third wavelength (A3). In the presence of the energy-donor material (ED1), the DSC has a fourth IPCE at the third wavelength (A3) greater than the third IPCE.

FIG. 5 is a diagram depicting the molecular structure of 1,6,9-tris-(4-tert-butylphenoxy)-N-(2,6-diisopropyl phenyl)perylene-3,4-dicarboximide (TTBPP). In an attempt to compensate for the strong yet narrow absorption window for ZnP being used as D1, the potential for improving the photovoltaic performance of ZnP in DSC via FRET was investigated using a perylene-based energy transfer dye (TTBPP) as ED1. TTBPP was judiciously chosen due to the fact that is belongs to a class of materials that exhibit appreciable chemical, thermal, and photochemical stability, and high fluorescence quantum yields, as well as synthetic accessibility. Conveniently, TTBPP exhibits good solubility in a variety of organic solvents while the appended tert-butylphenoxy groups effectively suppress molecular aggregation.

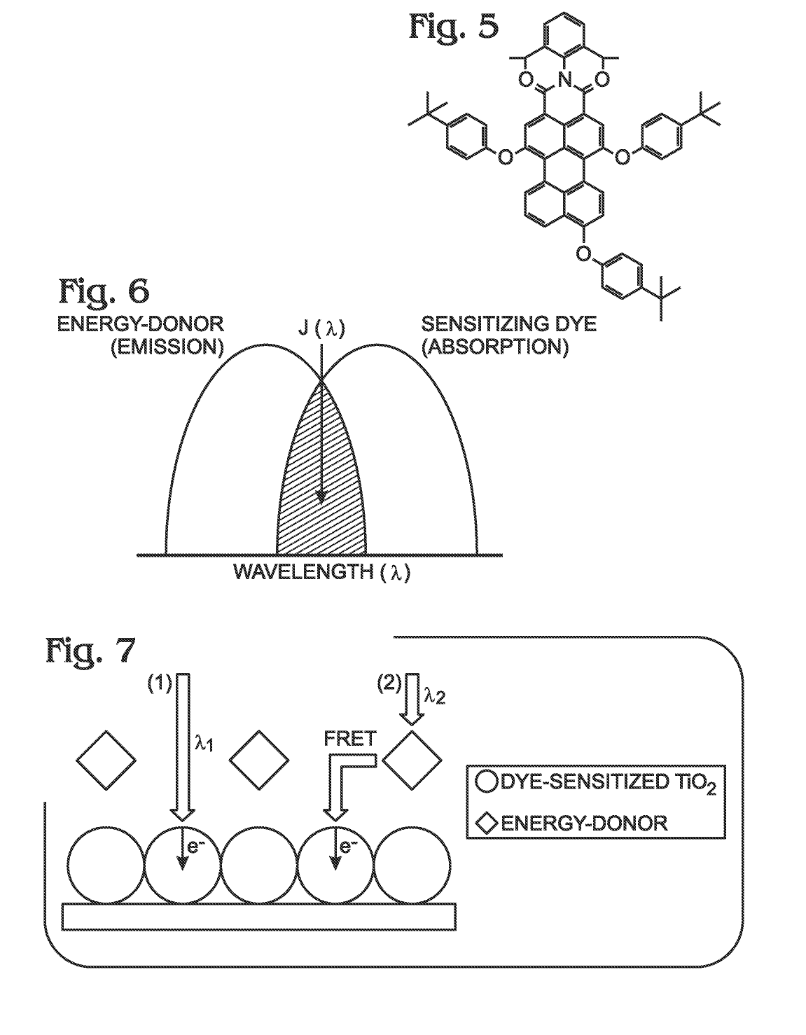

FIG. 6 is an illustration of effective spectral matching for Förster resonance energy transfer (FRET) from a photo-excited energy-donor to a sensitizing dye. In simple terms, the basic requirements for FRET to occur include: (1) the necessity for the interacting chromophores (donor and acceptor) to be located within close proximity, (2) the existence of a spectral overlap between the fluorescence spectrum of the donor and the absorption spectrum of the acceptor (sensitizer), and (3) dipole-dipole coupling of donor and acceptor through an electric field. Selection of the appropriate donor and acceptor candidates is dependent upon careful “spectral matching” using the emission and absorption spectra of the donor and acceptor, respectively, as indicated within the context of the DSC in the figure.

FIG. 7 is an illustration of the operative mechanisms in FRET-based DSC. The first mechanism (1) is irradiation of a sensitizer attached to nanoparticle TiO₂, which leads to direct electron injection from the photo-excited dye to TiO₂. The second mechanism (2) is irradiation of an energy-donor dissolved in electrolyte, which proceeds with FRET to the sensitizing dye, from which subsequent electron injection from the photo-excited dye into TiO₂ occurs. The energy transfer dye or energy-donor material absorbs strongly at those wavelengths at which the sensitizer attached to the TiO₂ surface absorbs weakly. Under ideal conditions, the photo-excited energy-donor undergoes FRET to the sensitizer, which leads to a photo-excited state from which electron injection to TiO₂ can proceed. In light of the fact that energy transfer is an energetically downhill process, the absorption of higher energy photons (relative to the sensitizer) is the role of the energy-donor material. Since electron injection to TiO₂ occurs efficiently from a sensitizer attached to the TiO₂ surface, the energy-donor promotes enhanced electron injection from the sensitizer to TiO₂ in an indirect manner, as indicated.

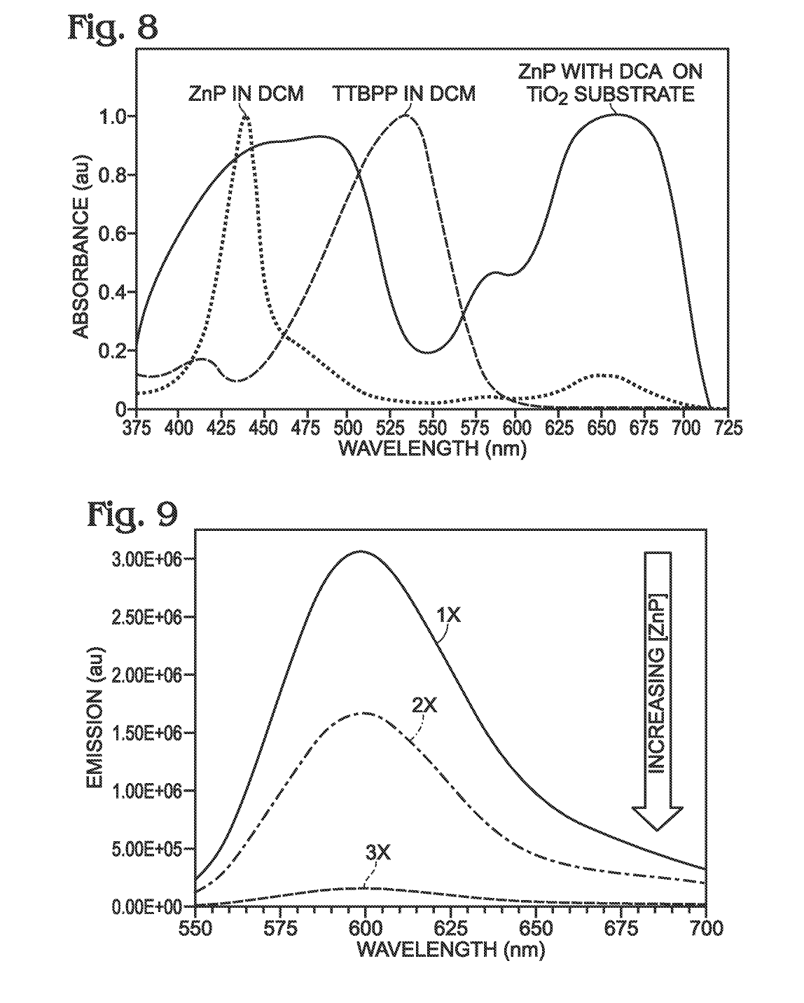

FIG. 8 is a graph depicting the optical absorption spectra of ZnP and TTBPP in dichloromethane (DCM), and ZnP co-adsorbed onto transparent TiO₂ substrates with deoxycholic acid (DCA) at a 1:1 molar ratio from 375-725 nm. In the figure, the absorption spectrum of TTBPP was normalized to match the absorbance maximum of TTBPP (λₘₐₓ=534 nm) with ZnP (in DCM) at λ=439 nm [y-axis: Absorbance in arbitrary units (au); x-axis: Wavelength in nanometers (nm)]. As previously mentioned, porphyrins suffer from a deficiency in optical absorbance along the wavelength region located between the Soret and Q-bands. In general, ZnP in DCM exhibits the characteristic absorption features for the Soret (λₘₐₓ=439 nm) and lower energy Q-bands (λₘₐₓ=581 and 651 nm), which are amplified following adsorption on TiO₂. In contrast, TTBPP exhibits strong absorbance in the wavelength regions located between the ZnP Soret and Q-bands, which is accompanied by weaker absorbance at λ=415 nm.

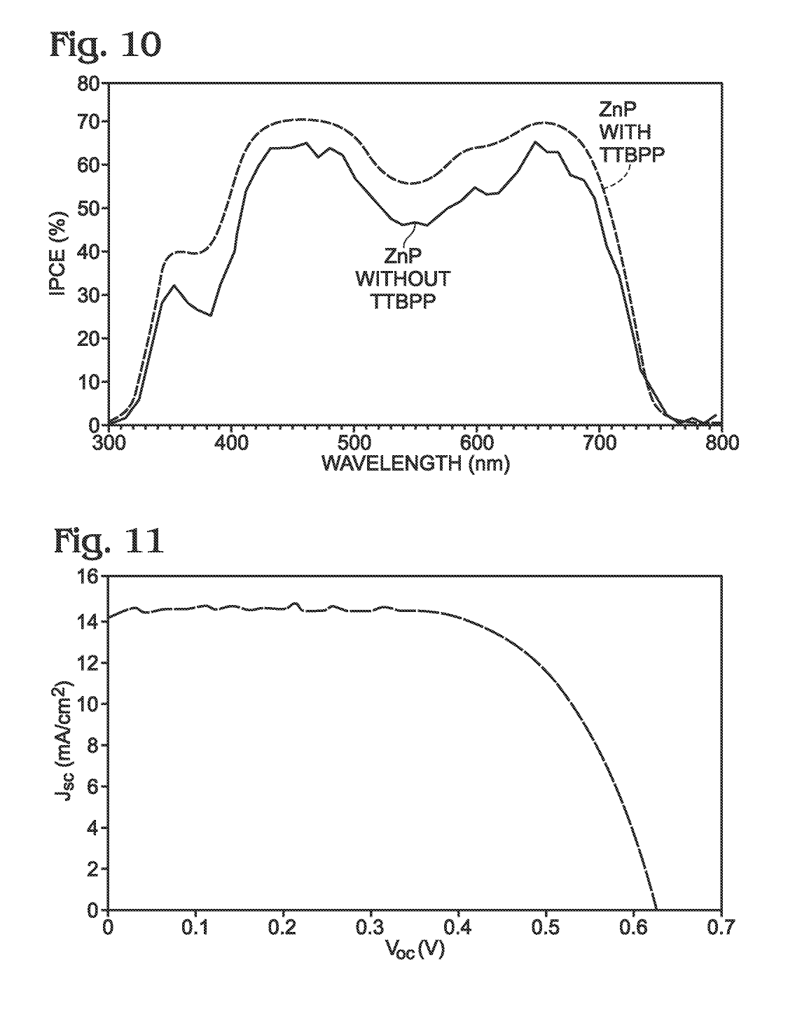

FIG. 9 is a graph depicting the emission spectra of TTBPP in DCM following irradiation at λ=534 nm, while monitoring at 550-700 nm. [y-axis: Emission in arbitrary units (au); x-axis: Wavelength in nanometers (nm)]. In order to evaluate the potential for FRET as a viable strategy for increasing photovoltaic performance in DSC using ZnP as sensitizer, a series of solution-based fluorescence “quenching” experiments were performed using a mixture of TTBPP and ZnP dissolved in DCM. To summarize, individual solutions of TTBPP and ZnP were prepared wherein the concentration of TTBPP was maintained constant while increasing the concentration of ZnP to 2× and 3× of the original concentration (1×). Emission data for TTBPP was collected from 550-700 nm following irradiation of the mixtures of TTBPP and ZnP at the maximum absorbance peak of TTBPP (λₘₐₓ=534 nm). As shown, significant “quenching” of TTBPP emission (reduced emission) is observed with an increasing concentration of ZnP. Overall, this result unambiguously indicates the efficient quenching of photo-excited TTBPP emission by ZnP through an energy transfer process in solution. Noteworthy is the fact that the emission from photo-excited TTBPP occurs at the onset of Q-band absorption for ZnP, thereby providing excellent spectral matching for FRET.

FIG. 10 is a graph of IPCE spectra for DSCs fabricated using ZnP with triiodide electrolyte and ZnP containing 6 mM dissolved TTBPP in triiodide electrolyte from 300-800 nm. For both DSCs, ZnP was co-adsorbed with DCA onto TiO₂ from the same solution in a 1:1 molar ratio. [y-axis: IPCE in percent (%); x-axis: Wavelength in nanometers (nm)]. As previously mentioned, in order for FRET to proceed efficiently, the energy-donor material must be accommodated in close proximity to the sensitizer attached to the TiO₂ surface. For proof-of-concept, a conventional triiodide (I⁻/I₃_{^{−}}) electrolyte-based DSC platform was employed. First, a mixture of ZnP and DCA was co-adsorbed in a 1:1 molar ratio onto a TiO₂ nanoparticle electrode. Separately, TTBPP was dissolved in triiodide electrolyte at 6 mM concentration. Both DSC prototypes were fabricated from a ZnP-sensitized TiO₂ electrode. The photovoltaic enhancement in the 500 nm to 650 nm region for the FRET-based DSC is an obvious indication of the constructive energy-transfer processes operative within the device.

FIG. 11 is a graph of the photovoltaic characteristics for a DSC fabricated using ZnP with triiodide electrolyte, containing 6 mM dissolved TTBPP. For the DSC, ZnP was co-adsorbed with DCA onto TiO₂ from the same solution in a 1:1 molar ratio. The J_{sc}-V_{oc} curve corresponds to the same FRET-based DSC for which the IPCE spectrum is presented in FIG. 10: [y-axis: short-circuit current density (J_{sc}) in mA/cm²; x-axis: open-circuit voltage (V_{oc}) in volts (V)]. Overall, the FRET-based DSC using ZnP as a sensitizer and TTBPP as an energy-donor demonstrated a short-circuit current density (J_{sc})=14.4 mA/cm², open-circuit voltage (V_{oc})=0.627 V, fill factor (FF)=65.6, and efficiency (η)=5.92% as compared to η=4.67% for a control DSC fabricated from ZnP sensitized-TiO₂ without TTBPP dissolved in the electrolyte. Although the photovoltaic characteristics shown in the figure are representative of the FRET-based DSC prototypes realized using the technology described herein, the champion FRET-based DSC yielded η=7.54% (J_{sc}=18.7 mA/cm², V_{oc}=0.590 V, FF=68.1).

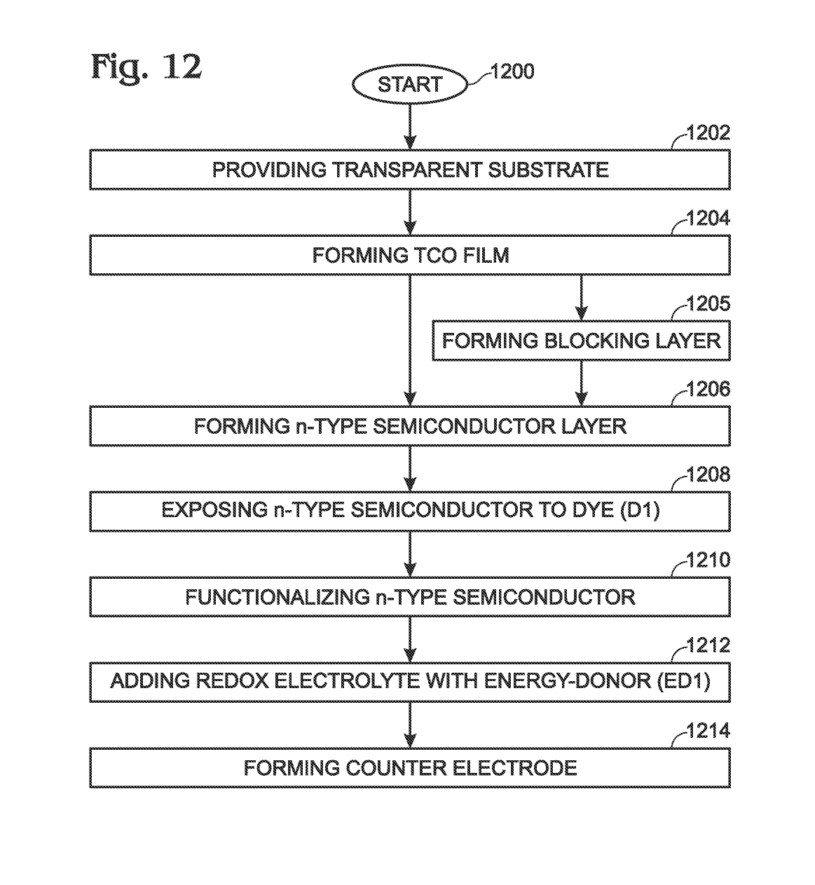

FIG. 12 is a flowchart illustrating a method for fabricating a dye-sensitized solar cell with energy-donor enhancement. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 1200.

Step 1202 provides a transparent substrate. Step 1204 forms a transparent conductive oxide (TCO) film overlying the transparent substrate. Step 1206 forms an n-type semiconductor layer overlying the TCO. The n-type semiconductor layer may be a metal oxide of titanium (TiO₂), aluminum (Al₂O₃), tin (SnO₂), magnesium (MgO), tungsten (WO₃), niobium (Nb₂O₅), or mixed metal oxides including more than one type of metal. The n-type semiconductor layer may take the form of nanoparticles, nanotubes, nanorods, nanowires, or combinations of the above-mentioned morphologies.

In one aspect, Step 1205 forms a blocking layer interposed between the TCO film and the sensitized n-type semiconductor layer. Step 1208 exposes the n-type semiconductor layer to a dissolved dye (D1) having a first optical absorbance local maxima at a first wavelength (A1) and a second optical absorbance local maxima at a second wavelength (A2), longer than the first wavelength. In one aspect, the dissolved dye (D1) is a porphyrin material. More particularly, the porphyrin material may be a metalloporphyrin obtained by complexation with a transition metal. For example, the metalloporphyrin may be zinc porphyrin (ZnP).

Step 1210 functionalizes the n-type semiconductor layer with the dye (D1), forming a sensitized n-type semiconductor layer. Step 1212 adds a redox electrolyte, including a dissolved energy-donor material (ED1), in contact with the sensitized n-type semiconductor layer. The redox electrolyte may be in the form of a liquid, solid, semi-solid, ionic liquid, or combinations of the above-mentioned forms. The energy-donor material (ED1) is capable of non-radiative energy transfer to the dye (D1). The energy-donor (ED1) has a third optical absorbance local maxima at a third wavelength (A3) between the first wavelength (A1) and the second wavelength (A2), and a first optical emission local maxima between the third wavelength (A3) and the second wavelength (A2). The energy-donor material (ED1) may be a perylene-monoimide material or a chemically modified perylene-monoimide material. For example, the perylene-monoimide material may be 1,6,9-tris-(4-tert-butylphenoxy)-N-(2,6-diisopropyl phenyl)perylene-3,4-dicarboximide (TTBPP). Step 1214 forms a counter electrode overlying the redox electrolyte.

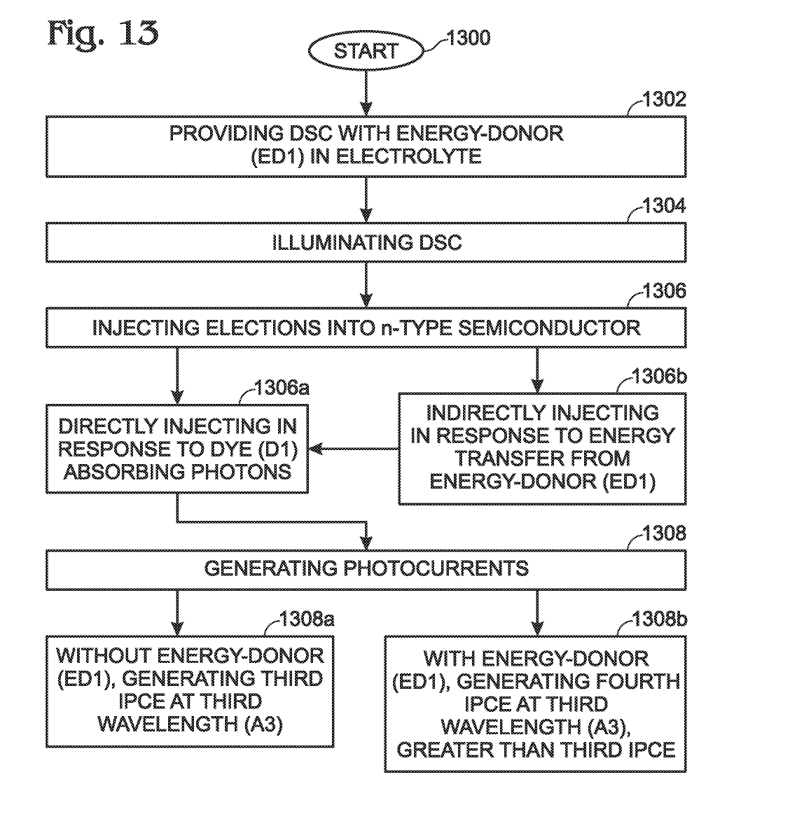

FIG. 13 is a flowchart illustrating a method for generating photocurrent using a dye-sensitized solar cell with energy-donor enhancement. The method begins at Step 1300.

Step 1302 provides a DSC with a TCO film overlying transparent substrate, an n-type semiconductor layer overlying the TCO sensitized with a dye (D1), a redox electrolyte including a dissolved energy-donor material (ED1) in contact with the sensitized n-type semiconductor layer, and a counter electrode overlying the redox electrolyte. Optionally, the DSC includes a blocking layer, as described above. Step 1304 illuminates the DSC with light. For example, the light may correspond to the ultraviolet (UV), visible, NIR, and IR spectrums. Step 1306 injects electrons from the dye (D1) into the n-type semiconductor using the following substeps. Step 1306a directly injects electrons in response to the dye (D1) absorbing incident photons. Step 1306b indirectly injects electrons in response to energy transfer to dye (D1) from the energy-donor material (ED1). Step 1308 generates photocurrents in response to the electrons injected from the dye (D1) into the n-type semiconductor.

In one aspect, the dye (D1) of Step 1302 has a first optical absorbance local maxima at a first wavelength (A1) and a second optical absorbance local maxima at a second wavelength (A2), longer than the first wavelength. The energy-donor material (ED1) of Step 1302 has a third optical absorbance local maxima at a third wavelength (A3) between the first wavelength (A1) and the second wavelength (A2), and a first optical emission local maxima between the third wavelength (A3) and the second wavelength (A2).

In another aspect, generating photocurrents in response to the electrons injected into the n-type semiconductor (Step 1308) includes substeps. In Step 1308a, without the presence of the energy-donor (ED1), the DSC has a first incident photon-to-current conversion efficiency (IPCE) at the first wavelength (A1), a second IPCE at the second wavelength (A2), and a third IPCE at the third wavelength (A3). In Step 1308b, the DSC containing the energy-donor material (ED1) has a fourth IPCE at the third wavelength (A3) greater than the third IPCE.

A DSC has been provided that is enhanced with an energy-donor material in the electrolyte. Examples of particular dyes and energy-donor materials have been provided as examples to illustrate the invention. However, the invention is not limited to merely these examples. Other variations and embodiments of the invention will occur to those skilled in the art.

We claim:

1. A dye-sensitized solar cell (DSC) with energy-donor enhancement, the DSC comprising:
a transparent substrate;
a transparent conductive oxide (TCO) film overlying the transparent substrate;
an n-type semiconductor layer overlying the TCO film, sensitized with a dye (D1);
a redox electrolyte, in contact with the sensitized n-type semiconductor layer, and including an energy-donor material (ED1) dissolved in the redox electrolyte;
a counter electrode overlying the redox electrolyte; and,
wherein the dye (D1) is capable of charge transfer at a surface of the n-type semiconductor, and has a first optical absorbance local maxima at a first wavelength (A1) and a second optical absorbance local maxima at a second wavelength (A2), longer than the first wavelength; and,
wherein the energy-donor material (ED1) is capable of non-radiative energy transfer to the dye (D1), has a third optical absorbance local maxima at a third wavelength (A3) between the first wavelength (A1) and the second wavelength (A2), and a first optical emission local maxima between the third wavelength (A3) and the second wavelength (A2).

2. The DSC of claim 1 wherein the dye (D1) includes a porphyrin material.

3. The DSC of claim 2 wherein the porphyrin material is a metalloporphyrin obtained by complexation with a transition metal.

4. The DSC of claim 3 wherein the metalloporphyrin is zinc porphyrin (ZnP).

5. The DSC of claim 1 wherein the energy-donor material (ED1) includes a material selected from a group consisting of a perylene-monoimide material and a chemically modified perylene-monoimide material.

6. The DSC of claim 5 wherein the perylene-monoimide material is 1,6,9-tris-(4-tert-butylphenoxy)-N-(2,6-diisopropyl phenyl)perylene-3,4-dicarboximide (HTTBPP).

7. The DSC of claim 1 wherein the dye (D1) is functionalized to the n-type semiconductor layer.

8. The DSC of claim 1 wherein the redox electrolyte is in a form selected from a group consisting of liquid, solid, semi-solid, ionic liquid, and combinations of the above-mentioned forms.

9. The DSC of claim 1 wherein the n-type semiconductor layer is selected from a group consisting of metal oxides of titanium (TiO₂), aluminum (Al₂O₃), tin (SnO₂), magnesium (MgO), tungsten (WO₃), niobium (Nb₂O₅), and mixed metal oxides including more than one type of metal.

10. The DSC of claim 1 wherein the n-type semiconductor layer has a form selected from a group consisting of nanoparticles, nanotubes, nanorods, nanowires, and combinations of the above-mentioned morphologies.

11. The DSC of claim 1 further comprising:
a blocking layer interposed between the TCO film and the co-sensitized n-type semiconductor layer.

12. The DSC of claim 1 wherein the DSC has a first incident photo-to-current conversion efficiency (IPCE) at the first wavelength (A1), a second IPCE at the second wavelength (A2), and a third IPCE at the third wavelength (A3); and,
wherein the DSC containing the energy-donor material (ED1) has a fourth IPCE at the third wavelength (A3) greater than the third IPCE.

13. A method for fabricating a dye-sensitized solar cell (DSC) with energy-donor enhancement, the method comprising:
providing a transparent substrate;
forming a transparent conductive oxide (TCO) film overlying the transparent substrate;
forming an n-type semiconductor layer overlying the TCO;
exposing the n-type semiconductor layer to a dissolved dye (D1) having a first optical absorbance local maxima at a first wavelength (A1) and a second optical absorbance local maxima at a second wavelength (A2), longer than the first wavelength;
functionalizing the n-type semiconductor layer with the dye (D1), forming a sensitized n-type semiconductor layer;
adding a redox electrolyte including a dissolved energy-donor material (ED1) in contact with the sensitized n-type semiconductor layer, where the energy-donor material (ED1) is capable of non-radiative energy transfer to the dye (D1), has a third optical absorbance local maxima at a third wavelength (A3) between the first wavelength (A1) and the second wavelength (A2), and a first optical emission local maxima between the third wavelength (A3) and the second wavelength (A2); and,
forming a counter electrode overlying the redox electrolyte.

14. The method of claim 13 wherein exposing the n-type semiconductor material to the dye (D1) includes the dissolved dye (D1) being a porphyrin material.

15. The method of claim 14 wherein the porphyrin material is a metalloporphyrin obtained by complexation with a transition metal.

16. The method of claim 15 wherein the metalloporphyrin is zinc porphyrin (ZnP).

17. The method of claim 13 wherein adding the redox electrolyte with the dissolved energy-donor material (ED1) includes the energy-donor material (ED1) being a material selected from a group consisting of a perylene-monoimide material and a chemically modified perylene-monoimide material.

18. The method of claim 17 wherein the perylene-monoimide material is 1,6,9-tris-(4-tert-butylphenoxy)-N-(2,6-diisopropyl phenyl)perylene-3,4-dicarboximide (TTBPP).

19. The method of claim 13 further comprising:
forming a blocking layer interposed between the TCO film and the sensitized n-type semiconductor layer.

20. The method of claim 13 wherein adding the redox electrolyte with the dissolved energy-donor material (ED1) includes the redox electrolyte being in a form selected from a group consisting of liquid, solid, semi-solid, ionic liquid, and combinations of the above-mentioned forms.

21. The method of claim 13 wherein forming the n-type semiconductor layer overlying the TCO includes the n-type semiconductor layer being selected from a group consisting of metal oxides of titanium (TiO₂), aluminum (Al₂O₃), tin (SnO₂), magnesium (MgO), tungsten (WO₃), niobium (Nb₂O₅), and mixed metal oxides including more than one type of metal.

22. The method of claim 13 wherein forming the n-type semiconductor layer overlying the TCO includes the n-type semiconductor layer having a form selected from a group consisting of nanoparticles, nanotubes, nanorods, nanowires, and combinations of the above-mentioned morphologies.

23. A method for generating photocurrent using a dye-sensitized solar cell (DSC) with energy-donor enhancement, the method comprising:
providing a DSC with a transparent conductive oxide (TCO) film overlying transparent substrate, an n-type semiconductor layer overlying the TCO sensitized with a dye (D1), a redox electrolyte including a dissolved energy-donor material (ED1) in contact with the sensitized n-type semiconductor layer, and a counter electrode overlying the redox electrolyte;
illuminating the DSC;
injecting electrons from the dye (D1) into the n-type semiconductor directly in response to the dye (D1) absorbing incident photons, and indirectly in response to energy transfer to dye (D1) from the energy-donor material (ED1); and,
generating photocurrents in response to the electrons injected from the dye (D1) into the n-type semiconductor.

24. The method of claim 23 wherein providing the DSC includes the dye (D1) having a first optical absorbance local maxima at a first wavelength (A1) and a second optical absorbance local maxima at a second wavelength (A2), longer than the first wavelength, and includes the energy-donor material (ED1) having a third optical absorbance local maxima at a third wavelength (A3) between the first wavelength (A1) and the second wavelength (A2), and a first optical emission local maxima between the third wavelength (A3) and the second wavelength (A2).

25. The method of claim 23 wherein generating photocurrents in response to the electrons injected into the n-type semiconductor includes:
the DSC having a first incident photon-to-current conversion efficiency (IPCE) at the first wavelength (A1), a second IPCE at the second wavelength (A2), and a third IPCE at the third wavelength (A3); and,
the DSC containing the energy-donor material (ED1) having a fourth IPCE at the third wavelength (A3) greater than the third IPCE.
